(19) United States
(12) Patent Application Publication
(10) Pub. No.: US 2010/0281624 A1
(43) Pub. Date: Nov. 11, 2010

(54) METHOD OF TREATING FABRIC

(76) Inventors: Somnath Das, Bangalore (IN); Amitava Pramanik, Bangalore (IN); Poulami Sengupta, Kolkata (IN); Gopa Kumar Velayudhan Nair, Bangalore (IN)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/676,145

(22) PCT Filed: Aug. 28, 2008
(86) PCT No.: PCT/EP2008/061287

§ 371 Date: Jun. 21, 2010

(30) Foreign Application Priority Data
Sep. 5, 2007 (IN) 1691/MUM/2007

(51) Int. Cl. C11D 3/00

(52) U.S. Cl. 8/115.51

(57) ABSTRACT

The present invention provides a method or treating a fabric comprising the steps of: a) contacting the fabric with a compound of an alkaline earth metal, titanium or zinc, followed by; b) contacting the fabric with C8-C24 soap, and; contacting the fabric with a water soluble compound of aluminium prior to or concurrent with the step (b), where each of the steps is carried out in presence of an aqueous carrier.

### TECHNICAL FIELD

This invention relates to a method of treating a fabric. It particularly relates to a multi-step method of treating a fabric to reduce subsequent soiling.

### BACKGROUND AND PRIOR ART

Conventional cleaning methods are directed towards effective cleaning of soils from the fabrics. Some cleaning formulations include soil release agents that make it easier for oily soils to be cleaned from fabrics. However, conventional cleaning formulations do not help much in reducing subsequent post-wash soiling of the fabric.

On the other hand, various industrial treatments for fabric modification are known to render the fabric hydrophobic by lowering surface energy or by providing a surface texture with optimum roughness or by a combination of both the approaches. The fabric modification of this type is normally carried out during textile manufacture and involves use of expensive and/or hazardous chemicals, special equipment, and hazardous process conditions (high temperature, use of steam etc.), and consequently, such processes are relatively difficult to be conveniently used in household.

### OBJECTS OF THE INVENTION

It is an object of the present invention to overcome or ameliorate at least one of the disadvantages of the prior art, or to provide a useful alternative.

One of the objects of the present invention is to provide a method of treating a fabric to render the fabrics relatively more hydrophobic.

Another object of the present invention is to provide a method of treating a fabric to reduce subsequent soiling.

A further object of the present invention is to provide a relatively more convenient method of treating a fabric to reduce subsequent soiling that can be used in household.

Present inventors have surprisingly found that a multi-step method of treating a fabric with a compound of alkaline earth metal, titanium or zinc, with a water soluble compound of aluminium, and with C8-C24 soap, in presence of an aqueous carrier, renders the fabrics hydrophobic and reduces subsequent soiling.

### SUMMARY OF THE INVENTION

According to the present invention there is provided a method for treating a fabric comprising the steps of:
a) contacting the fabric with a compound of alkaline earth metal, titanium or zinc, followed by;
b) contacting the fabric with C8-C24 soap, and;
   contacting the fabric with a water soluble compound of aluminium prior to or concurrent with the step (b), where each of the steps is carried out in presence of an aqueous carrier.

### DETAILED DESCRIPTION

According to the present invention there is provided a method for treating a fabric comprising the steps of:
a) contacting the fabric with a compound of alkaline earth metal, titanium or zinc, followed by;
b) contacting the fabric with C8-C24 soap, and;
   contacting the fabric with a water soluble compound of aluminium prior to or concurrent with the step (b), where each of the steps is carried out in presence of an aqueous carrier.

Each of the steps, i.e. the step (a), step (b) and the step of contacting with the aluminium compound, is carried out in presence of an aqueous carrier. The aqueous carrier can be different in each step. Alternatively, when some of the steps are concurrent, the aqueous carrier in the concurrent steps is identical.

The term “liquor to cloth ratio” or L/C ratio as used herein means the ratio of mass of the aqueous carrier that is in contact with the fabric to the mass of the fabric. The liquor to cloth ratio may be different in each step.

It is preferably that the liquor to cloth ratio in each step is preferably from 2 to 100, more preferably from 5 to 50, most preferably from 5 to 20.

The term “area of the fabric contacted” as used herein refers to apparent surface area of any one side of the fabric that is contacted with an aqueous carrier together with a soap, a water soluble compound of aluminium or a compound of alkaline earth metal, titanium or zinc.

The term “water soluble” as used herein refers to a substance having solubility of greater than 0.1 g per 100 g of water at a temperature of 25° C.

Compound of Alkaline Earth Metal, Titanium or Zinc

The process of the present invention comprises a step of contacting the fabric with a compound of alkaline earth metal, titanium or zinc. A compound of magnesium or zinc is particularly preferred.

The compound of the step (a) according to the present invention is a salt, an oxide or a hydroxide, or mixtures thereof. The compound is preferably mixed with an aqueous carrier prior to contacting with fabric.

The amount of the compound of the step (a) is preferably from 0.01 to 25, more preferably from 0.15 to 10, and most preferably from 0.15 to 5 mg per cm² of the fabric area.

The compound of the step (a) is preferably selected from oxide or hydroxide. The compound is more preferably selected from zinc oxide or zinc hydroxide.

According to an alternate aspect, the compound of the step (a) is a salt, preferably a water soluble salt. Suitable water soluble salt according to the present invention includes salts of mineral and carboxylic acids. Some examples of water soluble salts include chloride, nitrate, and acetate.

The compound of the step (a) may be preferably comprised within a fabric cleaning composition, more preferably within a detergent-based cleaning composition. The compound of the step (a) is preferably from 0.1 to 90%, more preferably from 10 to 60%, and most preferably from 30 to 50% by weight of the cleaning composition.

Soap

The fabric is contacted with C8-C24 soap, preferably, C10-C20 soap, and more preferably C12-C18 soap. The soap is preferably mixed with an aqueous carrier prior to contacting with fabric.

The soap may or may not have one or more carbon-carbon double bond or triple bond. The iodine value of the soap, which is indicative of degree of unsaturation, is preferably less than 20, more preferably less than 10, and most preferably less than 5. Saturated soap having no carbon-carbon double bond or triple bond is particularly preferred.

The soap may be water soluble or water insoluble. According to a preferred aspect, the soap is water soluble. Non-limiting examples of water soluble soaps that can be used according to the present invention include sodium laurate, sodium caprylate, and sodium myristate.

The amount of the soap is preferably from 0.01 to 25, more preferably from 0.01 to 10, and most preferably from 0.05 mg to 15 mg per cm² of the fabric area.

It is envisaged that the fabric is contacted with the soap that is generated in-situ. Accordingly, a precursor C8-C24 fatty acid capable of reacting with an alkali to generate soap in-situ, is contacted with the fabric in presence of an additional alkaline agent. It is preferred that an additional alkaline agent is contacted with the fabric. Preferred additional alkaline agent includes sodium carbonate or sodium hydroxide. The step of contacting the additional alkaline agent with the fabric is preferably concurrent with the step (a) or the step (b).

Preferably, the soap is contacted with the fabric during rinsing, after the fabric has been contacted with the compound of alkaline earth metal, titanium or zinc. It is preferred that the soap is comprised within a fabric conditioner composition. The soap is preferably from 0.1 to 50%, more preferably from 1 to 40%, and most preferably from 2 to 20% by weight of the fabric conditioner composition.

Water Soluble Compound of Aluminium

The process of the present invention includes a step of treating a fabric with a water soluble compound of aluminium. Preferably the compound of aluminium is mixed with an aqueous carrier prior to contacting with fabric.

The solubility of the compound of aluminium is preferably greater than 0.1, more preferably greater than 1 and most preferably greater than 5 g per 100 g of water at a temperature of 25° C.

The step of contacting the fabric with the compound of aluminium is either prior to or concurrent with the step of contacting with the soap. Preferably, the step of contacting the fabric with the compound of aluminium is concurrent with either step (a) or step (b).

All the following sequence of steps are within the scope of the present invention:

(i) The step of contacting the fabric with the compound of aluminium is concurrent with the step of contacting the fabric with the compound of alkaline earth metal, titanium or zinc. Preferably, the compound of aluminium is mixed with the compound of alkaline earth metal, titanium or zinc prior to contacting with the fabric.

(ii) The step of treating the fabric with the compound of aluminium is carried out after the step (a) and before the step (b), i.e. the step of contacting with the compound of aluminium is after the step of contacting the fabric with the compound of alkaline earth metal, titanium or zinc, and before the step of contacting the fabric with the soap.

(iii) The step of contacting with the compound of aluminium is concurrent with the step of contacting the fabric with the soap. Preferably, the compound of aluminium is mixed with the soap prior to contacting with the fabric.

It is envisaged that the compound of aluminium is contacted with the fabric concurrently with soap as well as the compound of alkaline earth metal, titanium or zinc. According to a preferred aspect, the compound of aluminium contacted concurrently with the soap is not same as the compound of aluminium contacted with the compound of alkaline earth metal, titanium or zinc.

The amount of the compound of aluminium is preferably from 0.01 to 50, more preferably from 0.1 to 10, and most preferably from 0.3 mg to 1.0 mg per cm² of the fabric area contacted.

The weight ratio of the compound of aluminium to the soap is preferably from 1:10 to 10:1, more preferably from 1:5 to 5:1, and most preferably from 1:2 to 2:1.

The weight ratio of the compound of aluminium to the compound of alkaline earth metal, titanium or zinc is preferably from 1:10 to 10:1, more preferably from 1:5 to 5:1, and most preferably from 1:2 to 2:1.

The compound of aluminium can be acidic or alkaline. Preferred acidic compound of aluminium includes aluminium salt of mineral acid. Some examples are aluminium nitrate, chloride, and sulphate. Preferred alkaline compound of aluminium includes aluminate of alkali metal. Sodium aluminate is a particularly preferred. It is preferable that the molar ratio of Na₂O to Al₂O₃ in sodium aluminate is from 1.5:1 to 1:1, more preferably from 1.3:1 to 1:1 and most preferably from 1.25:1 to 1.1:1.

Present inventors have found that choice of preference between alkaline and acidic compounds of aluminium depends on sequence of steps as well as on the type of compound of alkaline earth metal, titanium or zinc. Accordingly, the preference of choice between the acidic and alkaline sources of aluminium are described below.

When the compound of the step (a) is selected from zinc oxide, zinc hydroxide, or a salt of alkaline earth metal, zinc or titanium, the step of contacting the fabric with the compound of aluminium is preferably concurrent with the step (a). When the step of contacting the fabric with the compound of aluminium is concurrent with the step (a), it is particularly preferred that the compound of aluminium is acidic.

When the step of contacting with the compound of aluminium is concurrent with the step (b), it is particularly preferred that the compound of aluminium is alkaline. The reason for this preference is to avoid precipitation that may occur if an acidic compound of aluminium is used concurrently with soap.

When a precursor fatty acid is used to generate soap in-situ, it is preferred that the compound of aluminium is alkaline.

Preferred Ingredients and Sequence of Steps

Some examples of preferred combinations of the components along with the preferred order of addition are given below.

TABLE 1
Preferred ingredients and sequence of steps

| The compound of alkaline earth metal, | Compound | |
|---|---|---|
| titanium or zinc. (compound of the | of | Sequence |
| step (a)) | aluminium | of steps |
| Oxide of zinc or magnesium | Acidic | 1* |
| Oxide of magnesium | Alkaline | 1 |
| Zinc acetate dehydrate | Acidic | 1 |
| Magnesium sulphate heptahydrate | Acidic | 1 |
| Magnesium-Aluminium hydrotalcite | Acidic | 1 |
| dissolved in 1:1 hydrochloric acid | | |
| Oxide of magnesium, calcium, zinc, | Alkaline | 2** |
| tiatanium or barium | | |
| Oxide of zinc or sodium zincate | Acidic | 3*** |

1* - Step of contacting the fabric with the compound of aluminium is concurrent with the step (a).
2** - Step of contacting the fabric with the compound of aluminium is concurrent with the step (b).
3*** - Step of contacting the fabric with the compound of aluminium is after the step (a), and prior to the step (b).

According to a particularly preferred combination, the compound of the step (a) is an oxide of alkaline earth metal, the soap is sodium laurate, and the step of contacting the fabric with the oxide of alkaline earth metal is concurrent with the step of contacting with an alkaline compound of aluminium. The alkaline compound of aluminium is preferably sodium aluminate.

According to another particularly preferred combination, the compound of the step (a) is sodium zincate, the soap is sodium laurate, and the step of contacting the fabric with sodium zincate is concurrent with the step of contacting with an alkaline compound of aluminium. The alkaline compound of aluminium is preferably sodium aluminate.

Additional Features of the Process

It is envisaged that the process of the present invention is practiced in hand-washing of clothes as well as in washing machines.

It is preferred that agitation is provided, at least intermittently, during each step.

It is preferred that the process includes a step of rinsing with water after the step of contacting with the compound of alkaline earth metal, titanium or zinc.

It is preferred that the process includes a step of rinsing with water after the step of contacting the fabric with the compound of aluminium.

It is preferred that the process according to the present invention comprises a further step of drying. Drying is carried out preferably at a temperature from 5 to 250° C. after the step of contacting with the soap. The drying can be line drying or using clothes dryer.

The fabrics can be preferably subjected to a step of ironing the fabric. Fabrics can be ironed after contacting with the soap, preferably after the step of drying.

The Kit

According to another aspect, there is provided a kit comprising: (i) a compound of alkaline earth metal, titanium or zinc, (ii) water soluble aluminium compound, and (iii) soap, and instructions for use.

Each of the materials of the kit is preferably in form of solid powder or granules.

Each material is preferably packaged separately. More preferably, the water soluble aluminium compound is mixed with either the soap or the compound of alkaline earth metal, titanium or zinc.

### Examples

The invention will now be illustrated with help of examples. The examples are by way of illustration only and do not limit the scope of the invention in any manner.

Materials and Methods

The materials used are given in Table 2.

TABLE 2
Materials used in examples

| Materials: | Source |
|---|---|
| Magnesium oxide | Merck |
| Sodium aluminate | Rolex |
| Sodium laurate | Wilson Lab, Mumbai |
| Aluminium nitrate nonahydrate | Merck |
| Zinc oxide | Merck |
| Calcium oxide | Merck |
| Sodium hydroxide | Merck |
| Carbon soot N-220 | Cabot |
| Ferric oxide | Loba Chemie |
| Composite soil | China clay 95%, Silica 5% |
| | Carbon soot 2.5%, Iron |
| | oxide 2.5% |
| Linear alkylbenzene sulfonic | Advance detchem ltd |
| acid, sodium salt | |
| Zinc acetate dehydrate | s.d. fine chemicals |
| Surf Excel ® detergent | Hindustan Unilever Ltd. |
| Aluminium sulphate | Merck |
| hexadecahydrate | |
| Magnesium sulphate heptahydrate | Merck |
| Titanium dioxide P25 | Degussa |
| Barium hydroxide | Synthesized from barium |
| | chloride and sodium |
| | hydroxide |
| Cotton (100%) | Bombay Dyeing, Mumbai |
| Polycotton (67% polyester:33% | Bombay Dyeing, Mumbai |
| cotton) | |
| Polyester (100%) | WFK, Germany |
| Deionized water | Scientific Distillery |
| | Works, Bangalore |

In addition to the above materials, various staining solutions were prepared to mimic stains that are commonly encountered. The staining solutions include carbon soot slurry, iron oxide slurry, grass, black tea, coffee, mud and aerated soft drink.

Carbon Soot Slurry

In 1 L deionized water, 150 mg of carbon soot N-220 was added along with 50 mg of sodium salt of linear alkyl benzene sulfonic acid. The slurry was sonicated in a bath sonicator (ICW Private Limited, Pune, India) using water as a medium for 90 minutes at room temperature to get carbon soot slurry.

Iron Oxide Slurry

Iron oxide slurry was prepared by adding 1 g ferric oxide to 1 L of deionized water and sonicating in a probe sonicator at for 90 minutes.

Grass Stain

Grass stain was prepared by blending 100 gm of fresh grass with 100 mL of deionized water in a food blender for 5 minutes and filtering the liquor using a desized cotton cloth, followed by dilution of the solution to 500 mL.

Tea Stain

Tea stain was prepared by adding ten tea bags of Taj Mahal® Tea (Hindustan Unilever Limited) in 500 mL of deionized water at 90-100° C., followed by stirring for 2 minutes.

Coffee Stain

Coffee beverage collected from a Lipton® (Hindustan Unilever Limited) coffee vending machine was used for preparing coffee stain.

Mud Stain

Mud (red mud, collected from Bangalore) was dried in air and sieved using a sieve shaker to obtain particle sizes of approximately 90 microns or lower. 1 g of the sieved mud was added to 1 L of deionized water and sonicated in a bath sonicator using water as a medium for 90 minutes to get the mud slurry.

Aerated Soft Drink Stain

Commercially available carbonated soft drinks were used.

The Method of Treating Fabric

0.15 g (or the amount depending on the concentration given) of the compound of alkaline earth metal, titanium or zinc was added to 100 mL deionized water. In some cases, 0.15 g (or the amount depending on the concentration given) detergent was also added to this slurry. The slurry was stirred for 2-3 minutes and then five desized fabric swatches, each approximately 100 cm² area, and each weighing about 1.2 g, were added to it and soaked for 30 minutes. The liquor to cloth ratio was approximately 15. The fabric swatches were then taken out and soaked in 100 mL solution of the soap in deionized water for 30 minutes, with agitation. The liquor to cloth ratio was approximately 15. The swatches were then taken out, squeezed to remove the water, and line dried. The dried swatches were ironed using an electric hot iron from Philips. The order of contacting with the components was as described above unless specified otherwise.

The compound of aluminium was either added together with the compound of alkaline earth metal, titanium or zinc or with the soap, or contacted separately. In some cases, the fabric was contacted with the compound of aluminium, after it was contacted with the compound of alkaline earth metal, titanium or zinc, but before contacting with the soap. The sequence of steps is described in examples.

Measurement of Contact Angle

A (1 cm×3 cm) portion of the treated and the untreated swatch of fabric (cotton, polycotton or polyester) was cut and placed on a clean glass slide. The edges of the swatch were pasted to the slide using adhesive tape. The slide was placed on a goniometer (Kruss) and 5 μL drop of deionized water was placed on the fabric secured to the slide, using a needle controlled by using mechanized controller. The time at which the drop was placed on the surface of the fabric swatch was noted using a stopwatch. The contact angle was measured from the image of the drop taken at 5 minutes intervals up to 15 minutes, or till the time drop completely wetted the surface of the fabric, whichever was higher. The contact angle is an indicator of hydrophobiciy of fabrics. Contact angle higher than 100 indicated that the fabric surface was hydrophobic, with the larger values of contact angle indicating relatively higher hydrophobicity. Hydrophobicity is in turn related to the extent to which the fabric is prone to soiling by aqueous soils. The higher values of contact angle, in particular greater than 100, indicated that the fabric was less prone to post-wash soiling. Other indicator of hydrophobicity is the time taken for a water drop placed on the fabric to wick and wet the surface entirely. Wicking of water drop of a drop of 5 μL volume on a fabric surface in less than 10 seconds indicated that the fabric was more prone to soiling. Wicking time of greater than 10 seconds indicated that the fabric was less prone to subsequent soiling. The time taken by the drop to completely wet the surface of the fabric was also recorded.

Measurement of Stain Repellency

Fabric swatches were evaluated for aqueous stain repellency. Staining solutions were poured in 500 mL stoppered plastic wash bottle equipped with a blunt plastic nozzle.

100 cm² pieces of the treated (or untreated) fabric swatches were cut and secured to a flat plate using binder clips. The plate was placed such that the fabric surface is vertically oriented. A staining solution was splashed onto the dry swatch, and the fabric was then brushed off with a tissue paper to remove the staining solution from the fabric. The fabric was dried if required, and placed in a scanner (HP scan Jet) The image captured using a scanner was analysed to estimate the extent of soiling. Average true colour of the image indicated the extent of soiling. True colour ranges from 0-256 with 256 indicating no staining whilst 0 indicating total staining. The experiment was carried using solutions of tea stain and carbon soot stain.

Stain repellency was also evaluated on shirts (cotton, polycotton and polyester) worn by users. Experiments were carried out using untreated shirts and shirts treated by the process of Example 8. The shirt was worn by a user.

Accidental staining of shirts was simulated by splashing various types of staining solutions (tea, coffee, iron oxide, grass, mud, soft drink) on the shirt worn by a user. The user then immediately brushed off the staining solution from the shirt. The extent of staining was evaluated visually.

Effect of Type of Oxide Compound of the Step (a)

Fabric: Bombay Dyeing cotton swatch

The compound of step (a): oxides given in Table 3, 1.5 g/L, L/C=15, 0.27 mg per cm² area of the fabric.

The soap: sodium laurate, 1 g/L, L/C=15, 0.18 mg per cm² area of the fabric.

The compound of aluminium: alkaline, sodium aluminate, 1 g/L, 0.18 mg per cm² area of the fabric.

Sequence of steps: Step of contacting the fabric with the compound of aluminium is concurrent with the step of contacting with the soap.

TABLE 3
Effect of type of oxide compound of the step (a)

| Example | The compound used |
|---|---|
| 1 | Calcium oxide |
| 2 | Barium oxide |
| 3 | Titanium dioxide |
| 4 | Zinc oxide |

Comparative examples 1-A, 2-A, 3-A and 4-A correspond to the examples 1-4, respectively, in all respects except that there is no treatment with the soap. Comparative example 1-B is for the treatment with the soap alone.

For the above examples, the effect on fabric surface on hydrophobilcity, as measured by wicking time, is given below

TABLE 4
Relative hydrophobicity of fabrics of Examples 1-4
and comparative examples 1A-4A and 1-B

| | Time for complete | |
|---|---|---|
| | drop disappearance | |
| Example | (sec) | Hydrophobic |
| 1 | 20 | Yes |
| 2 | 30 | Yes |
| 3 | 25 | Yes |
| 4 | 30 | Yes |
| 1-A | 0 | No |
| 2-A | 0 | No |
| 3-A | 0 | No |
| 4-A | 0 | No |
| 1-B | 0 | No |

From the results, it is clear that the fabric treated with the process of the present invention is rendered relatively more hydrophobic.

Effect of Amount of Magnesium Oxide

Type of fabric: cotton, polycotton and polyester.

The compound of step (a): magnesium oxide, added with Surf Excel®, L/C=15.

The soap: sodium laurate, 1 g/L, L/C=15, 0.18 mg/cm² fabric area contacted.

Compound of aluminium: alkaline, sodium aluminate, 1 g/L, 0.18 mg/cm² fabric area contacted.

Sequence of steps: Step of contacting the fabric with the compound of aluminium is concurrent with the step of contacting with the soap.

TABLE 5
Effect of amount of magnesium oxide

| | Concentration | Amount of Magnesium | Concentration |
|---|---|---|---|
| | of magnesium | oxide (mg per cm² of | of Surf |
| Example | oxide (g/L) | fabric area) | Excel ® (g/L) |
| 5 | 0.5 | 0.09 | 2.5 |
| 6 | 0.75 | 0.14 | 2.25 |
| 7 | 1.0 | 0.18 | 2 |
| 8 | 1.5 | 0.27 | 1.5 |
| 9 | 1.5 | 0.27 | 0 |

Comparative examples 5-A to 9-A correspond to the examples 5-9, respectively, in all respects except that there is no treatment with the soap. Comparative example 5-B is for the treatment with the soap alone.

For the above examples, the effect on fabric surface hydrophobilcity, as measured by contact angle on various fabrics, is given in Table 6.

TABLE 6
Relative hydrophobicity of fabrics of Examples 5-9
and comparative examples 5-A to 9-A and 5-B

| | Contact | Contact | Contact |
|---|---|---|---|
| | Angle | Angle | Angle |
| Example | (Cotton) | (Polycotton) | (Polyester) |
| 5 | 20 | 110 | 112 |
| 6 | 22 | 115 | 118 |
| 7 | 118 | 128 | 127 |
| 8 | 130 | 131 | 130 |
| 9 | 127 | 128 | 127 |
| 5-A | 0 | 0 | 0 |
| 6-A | 0 | 0 | 0 |
| 7-A | 0 | 0 | 0 |
| 8-A | 0 | 0 | 0 |
| 9-A | 0 | 0 | 0 |
| 5-B | 0 | 0 | 0 |

From the results, it is clear that the fabric contacted with magnesium oxide followed by concurrent contact with sodium aluminate and sodium laurate increases relative hydrophobicity of cotton, polycotton and polyester. Further, the amount of magnesium oxide from 0.15 to 5 mg per cm² of fabric contacted provides better results for cotton.

Stain Repellency

Stain repellency was evaluated using the procedure described earlier. The fabrics treated with the process of Example 8 were stained with carbon soot and with tea stain according to the staining procedure described earlier. Three types of fabric swatches, viz. cotton, polycotton and polyester were stained. Untreated fabrics were also stained in a similar manner. The extent of staining was evaluated by using image analysis. Average true colour of the image indicated the extent of soiling. True colour ranges from 0-256 with 256 indicating no staining whilst 0 indicating total staining. The results are given in Table 7.

TABLE 7
Stain Repellency

| | | True | True | |
|---|---|---|---|---|
| | | colour | colour | True colour |
| | Staining | value | value | value |
| Fabric | solution | (Cotton) | (Polycotton) | (Polyester) |
| Treated | Carbon soot | 252.9 | 254.7 | 245.7 |
| (Example 8) | | | | |
| Untreated | Carbon soot | 231.3 | 239.0 | 219.9 |
| Treated | Tea | 254.0 | 251.7 | 252.7 |
| (Example 8) | | | | |
| Untreated | Tea | 237.0 | 238.5 | 236.2 |

The results demonstrate that the fabric treated with the process of the present invention is relatively less prone to subsequent soiling.

Stain Repellency of Shirts Worn by Users

For various types of staining solutions including tea, coffee, iron oxide, grass, mud and soft drink, it was confirmed by visual observation that the extent of staining for the shirts treated with the process of Example 8 was significantly less than the staining of untreated shirts.

Effect of Amount of Magnesium Oxide and Detergent

The compound of step (a): magnesium oxide added together with Surf Excel®, L/C=50

The soap: sodium laurate, L/C=50

Compound of aluminium: acidic, aluminium nitrate, 1 g/L, 0.6 mg/cm² area of the fabric contacted

Sequence of steps: Step of contacting the fabric with the compound of aluminium is concurrent with the step of contacting with the compound of alkaline earth metal, titanium or zinc.

TABLE 8
Effect of amount of magnesium oxide and detergent

| | | | | Amount of |
|---|---|---|---|---|
| | | Amount of | | sodium |
| | | magnesium | | laurate |
| | Concentration | oxide (mg/cm² | Concentration | (mg/cm² |
| | of magnesium | fabric | of sodium | fabric |
| Example | oxide (g/L) | area) | laurate (g/L) | area) |
| 10 | 1.5 | 0.9 | 1.0 | 0.6 |
| 11 | 1.5 | 0.9 | 0.5 | 0.3 |
| 12 | 1.0 | 0.6 | 1.0 | 0.6 |

Comparative examples 10-A to 12-A correspond to the examples 10-12, respectively, in all respects except that there is no treatment with the compound of aluminium. For the above examples, the hydrophobilcity, as measured by contact angle, is given below.

TABLE 9
Hydrophobicity of fabrics of Examples 10-12 and
comparative examples 10-A to 12-A

| Example | Contact angle | Hydrophobic |
|---|---|---|
| 10 | 115 | Yes |
| 11 | 110 | Yes |
| 12 | 114 | Yes |
| 10-A | 0 | No |
| 11-A | 0 | No |
| 12-A | 0 | No |

The results show that the process of the present invention with various amounts of soap and magnesium oxide, provides relative hydrophobicity to the fabric.

Effect of Type of Salt of Alkaline Earth Metal or Zinc

The compound of step (a): Given in table 10, L/C=50

The soap: sodium laurate, L/C=50, 1 g/L in Ex 13, 4 g/L in Example 14.

Compound of aluminium: acidic (given in Table 10)

Sequence of steps: Step of contacting the fabric with the compound of aluminium is concurrent with the step of contacting with the compound of alkaline earth metal, titanium or zinc.

TABLE 10
Effect of type of compound of the step (a)

| | | Amount* | | Conc of | |
|---|---|---|---|---|---|
| | | of the | Amount* | acidic | Amount* of |
| | | compound | of | compound of | acidic |
| | Compound of | of the | sodium | aluminium | compound of |
| Ex | the step (a) | step (a) | laurate | (g/L) | aluminium |
| 13 | Zinc acetate | 1.2 | 0.6 | 1.14 (Aluminium | 0.68 (Aluminium |
| | dihydrate (2 g/L), | (Zinc | | nitrate) + | nitrate) + |
| | Surf | acetate) | | 1.9 (Aluminium | 1.14 (Aluminium |
| | Excel ® (3 g/L) | | | sulphate) | sulphate) |
| 14 | Magnesium | 3 | 2.4 | 2.13 | 1.28 |
| | sulphate | | | (Aluminium | |
| | heptahydrate, | | | sulphate) | |
| | 5 g/L | | | | |

*mg per cm² of fabric area.

Comparative examples 13-A to 14-A correspond to the examples 13-14, respectively, in all respects except that there is no treatment with the compound of aluminium.

For the above examples, fabric surface hydrophobilcity, as measured by wicking time, is given below.

TABLE 11
Hydrophobicity of fabrics of Examples 13-14 and
comparative examples 13A-14A

| | Time for complete drop | |
|---|---|---|
| Example | disappearance (sec) | Hydrophobic |
| 13 | 22 | Yes |
| 14 | 16 | Yes |
| 13-A | 0 | No |
| 14-A | 0 | No |

The results demonstrate that soluble salts of zinc and magnesium can be used in the process of the present invention to render the fabrics relatively more hydrophobic.

Effect of Temperature

In following examples, all the conditions were identical to Example 8, except the temperature which was 25° C. in Example

TABLE 12
Effect of temperature

| | | Contact | | Contact |
|---|---|---|---|---|
| | Temperature | Angle | Contact Angle | Angle |
| Example | (° C.) | (Cotton) | (Polycotton) | (Polyester) |
| 15 | 10 | 128 | 131 | 128 |
| 16 | 60 | 120 | 125 | 125 |

The results demonstrate that the process of the present invention renders fabrics relatively hydrophobic over a range of temperature.

Overall results clearly demonstrate that the fabrics treated with the process of the present invention render the fabric relatively more hydrophobic, relatively less prone to subsequent soiling and that the process can be conveniently carried out in household.

1. A method for treating a fabric comprising the steps of:
a) contacting the fabric with a compound of an alkaline earth metal, titanium or zinc, followed by;
b) contacting the fabric with C8-C24 soap, and;
contacting the fabric with a water soluble compound of aluminium prior to or concurrent with the step (b), where each of the steps is carried out in presence of an aqueous carrier.

2. A method as claimed in claim 1 wherein the amount of said compound of the step (a) is from 0.01 to 25 mg per cm² of the fabric area.

3. A method as claimed in claim 1 wherein the amount of said soap is from 0.01 to 25 mg per cm² of the fabric area.

4. A method as claimed in claim 1 wherein the amount of said compound of aluminium is from 0.01 to 50 mg per cm² of the fabric area.

5. A method as claimed in claim 1 wherein said soap is water soluble.

6. A method as claimed in claim 1 wherein said compound of the step (a) is selected from a salt, an oxide, a hydroxide or mixtures thereof.

7. A method as claimed in claim 6 wherein said compound of the step (a) is selected from oxide or hydroxide.

8. A method as claimed in claim 1 wherein said compound of the step (a) is a compound of magnesium or zinc.
